(19) United States
(12) Patent Application Publication
(10) Pub. No.: US 2021/0042669 A1
(43) Pub. Date: Feb. 11, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/821,532

(22) Filed: Mar. 17, 2020

(30) Foreign Application Priority Data
Aug. 6, 2019 (JP) 2019-144646

(51) Int. Cl. G06Q 10/02

(52) U.S. Cl. CPC G06Q 10/02

(57) ABSTRACT

An information processing system comprising one or more processors programmed to: acquire information on a first reservation of a first place for a first time window, determine whether duration of actual use of the first place by a user is shorter than the first time window of the first reservation, and in response to determining that the duration is shorter than the first time window, make a second reservation to reserve the first place or a second, different place for a second time window.

### CROSS-REFERENCE TO RELATED APPLICATIONS

This application is based on and claims priority under 35 USC 119 from Japanese Patent Application No. 2019-144646 filed Aug. 6, 2019.

### BACKGROUND

### (i) Technical Field

The present disclosure relates to an information processing system, an information processing apparatus, and a non-transitory computer readable medium.

### (ii) Related Art

Japanese Unexamined Patent Application Publication No. 2002-279260 discloses determining whether or not a user who made a reservation arrives before a reserved time on the basis of a displacement value of a current position of a mobile information terminal, and if the user does not arrive before the reserved time, changing or cancelling the reservation and changing contents of a reservation table.

### SUMMARY

In a case where a user who made a reservation of a place for a certain time window arrives late at the place or leaves the place early, duration of actual use of the reserved place becomes shorter than the reserved time window.

The user may make another reservation by himself or herself to make up for the time he/she missed due to his/her late arrival or early leave. However, making another reservation is troublesome for the user, and such a troublesome operation discourages the user from making another reservation.

Aspects of non-limiting embodiments of the present disclosure relate to improving convenience of a user who uses a place which the user reserved as compared with a case where the user who arrives at the place later than a start time of a time window of the reservation or leaves the place before an end time of the time window of the reservation changes settings concerning the reservation.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising one or more processors programmed to: acquire information on a first reservation of a first place for a first time window, determine whether duration of actual use of the first place by a user is shorter than the first time window of the first reservation, and in response to determining that the duration is shorter than the first time window, make a second reservation to reserve the first place or a second, different place for a second time window.

### BRIEF DESCRIPTION OF THE DRAWINGS

An exemplary embodiment of the present disclosure will be described in detail based on the following figures, wherein:

FIG. 1 schematically illustrates an overall configuration of an information processing system;

FIG. 2 is a view for explaining an example of a booth-type space;

FIG. 3 is a view for explaining an example of a hardware configuration of a space management server;

FIG. 4 is a diagram illustrating an example of a hardware configuration of a user terminal;

FIG. 5 is a view for explaining an example of a functional configuration of the space management server;

FIG. 6 illustrates an example of a display screen displayed on a user terminal of a reservation applicant when the reservation applicant makes a reservation of a space;

FIG. 7 illustrates another example of a display screen displayed on the user terminal;

FIG. 8 illustrates a reservation list stored in an information storage unit of the space management server;

FIG. 9 illustrates an example of automatic reservation processing performed by the space management server;

FIG. 10 illustrates another example of the reservation list; and

FIG. 11 illustrates a space database.

### DETAILED DESCRIPTION

An exemplary embodiment of the present disclosure is described below with reference to the drawings.

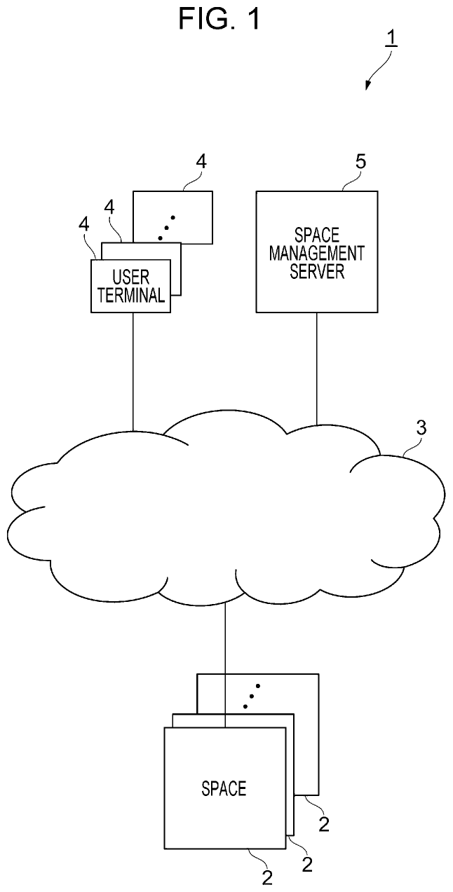

FIG. 1 schematically illustrates an overall configuration of an information processing system 1 according to the present exemplary embodiment.

In the present exemplary embodiment, plural spaces 2, each of which is an example of a place reserved and used by a user, are provided.

Examples of the spaces 2 include booths, guest rooms of a facility such as an accommodation facility, and conference rooms of a company. These are examples of the spaces 2 that are partitioned from surroundings by a wall, a partition, or the like. Furthermore, examples of the spaces 2 according to the present exemplary embodiment include tables and seats on which service is offered at a restaurant, a barber shop, or the like. These are examples of the spaces 2 opened to surroundings.

The information processing system 1 illustrated in FIG. 1 includes various terminals connected to a cloud network 3.

In FIG. 1, user terminals 4 operated by users and a space management server 5 that manages the spaces 2 are illustrated as examples of the terminals connected to the cloud network 3. Furthermore, the spaces 2 are connected to the cloud network 3. More specifically, various apparatuses are provided in the spaces 2, and these apparatuses are connected to the cloud network 3.

The spaces 2 may be managed by a single business operator or plural business operators. For example, different business operators may be in charge of management of reservations, management of entry into and exit from rooms, statuses of usage of rooms, and the like, management of charging of usage fees on users, and management of members registered as users.

As described above, the spaces 2 managed as targets reserved by users need not be spaces of the same type. For example, some of the spaces 2 may be booths, and some of the spaces 2 may be seats or tables of a restaurant or the like.

Furthermore, management of a single purpose or function may be provided by plural business operators in cooperation.

In the present exemplary embodiment, doors of the spaces 2 are equipped with an electronic lock so that the spaces 2 can be locked. In the present exemplary embodiment, persons who have an authority to unlock the spaces 2 can access the spaces 2.

To unlock a space 2, a person who tries to unlock the space 2 gives an unlocking instruction by operating his or her user terminal 4. This instruction is sent to the space management server 5, and the space management server 5 receives the instruction. Then, the space management server 5 gives an instruction to unlock the space 2 for which the unlocking instruction is aimed. This causes the electronic lock of the space 2 to operate, thereby unlocking the space 2.

In the present exemplary embodiment, it is assumed that the user terminals 4 are smartphones, which are portable. Note, however, that the portable user terminals 4 may be wearable terminals, notebook computers, or gaming terminals.

The space management server 5 manages various kinds of information related to the spaces 2. For example, the space management server 5 manages information for specifying users, information for specifying the spaces 2 reserved by users, start dates and times of reservations, and end dates and times of reservations.

Examples of the information for specifying users include users' names, genders, ages, accounts, passwords, and information for management given to the individuals. Examples of the information for specifying the spaces 2 used by users include information for specifying places such as addresses or locations and names and numbers for management.

The space management server 5 may manage reservations of articles and services associated with the spaces 2. For example, the space management server 5 may manage articles and services that are permitted to be borrowed or used and consumed or consumable articles and services.

Furthermore, the space management server 5 manages various kinds of information related to usage of the spaces 2. For example, the space management server 5 manages information on statuses of usage of the spaces 2 and information on users of the spaces 2.

Furthermore, the space management server 5 unlocks and locks the spaces 2.

### Appearance Configuration of Spaces 2

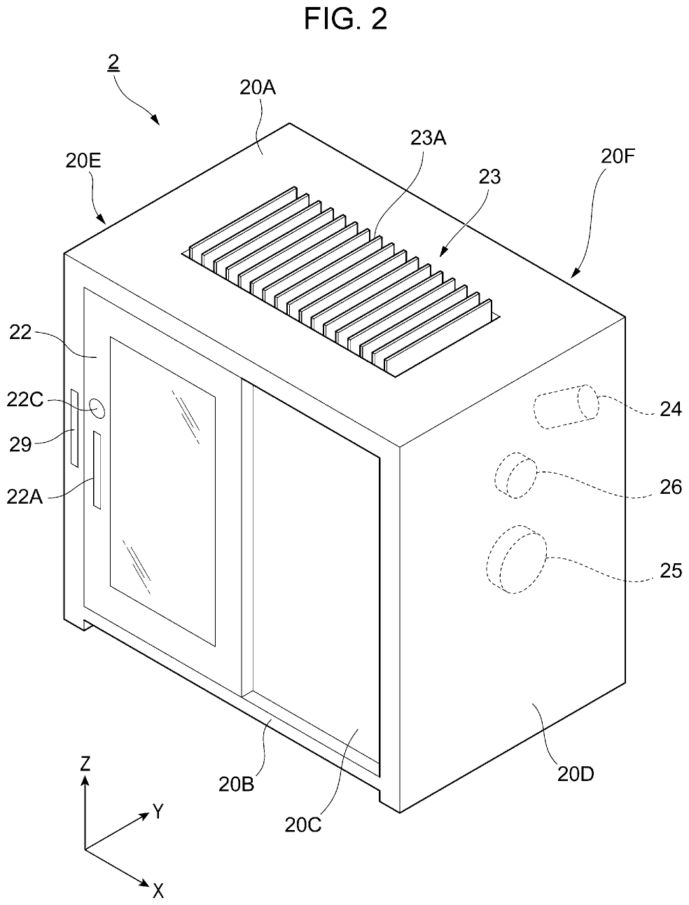

FIG. 2 is a view for explaining an example of a booth-type space 2.

The booth-type space 2 illustrated in FIG. 2 is placed at an indoor or outdoor place such as a train station, an airport, an office building, a commercial facility such as a restaurant or a department store, a bank, a library, an art museum, a museum, a public institution or facility, an accessway, or a park.

The booth-type space 2 illustrated in FIG. 2 is a closed-type booth provided with a ceiling. Note that the closed type does not mean “completely closed” and just needs to have practical sound insulation.

That is, the space 2 may have an opening or a gap such as an air inlet or a small window in a part of a body of the space 2. The window may be openable and closable.

The body of the space 2 illustrated in FIG. 2 includes a ceiling 20A, a floor 20B, a wall 20C equipped with a door 22, which is openable and closable, two walls 20D and 20E located on both sides of the wall 20C, and a wall 20F that faces the door 22.

In FIG. 2, the ceiling 20A has a ventilating hole 23. The ventilating hole 23 is provided with a louver 23A that can adjust an opening area. In FIG. 2, the louver 23A is fully opened.

In the present exemplary embodiment, an inside of the body and an outside of the body are communicated through the ventilating hole 23, and a temperature in the inside of the body and a temperature in the outside of the body are substantially equal accordingly. More specifically, in the present exemplary embodiment, no air-conditioning apparatus such as a heating apparatus or a cooling apparatus is provided in the body, and therefore the temperature in the inside of the body and the temperature in the outside of the body are substantially equal.

Note that an air-conditioning apparatus may be provided in the body so that the temperature in the inside of the body can be adjusted.

In the present exemplary embodiment, it is assumed that the door 22 is a sliding door that is movable along the wall 20C. Although the door 22 is a single sliding door that slides in one direction in FIG. 2, the door 22 may be a sliding doorset including two or more members sliding on respective lanes or a sliding doorset including two members sliding on a single lane.

In the present exemplary embodiment, the door 22 is provided with a handle 22A used by a user to open or close the door 22. Furthermore, the door 22 is provided with an electronic lock 22C that can lock and unlock the door 22.

The number of users which the space 2 accommodates is roughly determined by a volume of the space 2. In the present exemplary embodiment, it is assumed that the space 2 is a cabin-type space that is basically used by a single person.

Note, however, that the space 2 may be a large room that accommodates a large number of persons. The large room may be a single independent room or may be a room created by connecting plural rooms 2 by removing one of or both of the walls 20D and 20E of the spaces 2.

Note that the cabin type does not mean that only one person can use the space and means that a small number of persons (e.g., two or three persons) can use the space.

A shape and a structure of the body, equipment, and performance of the space 2 are not limited in particular. For example, the ceiling 20A may be removed.

In the present exemplary embodiment, a single desk and a single chair (not illustrated) are placed in the body. Furthermore, supplied equipment and apparatuses, reserved equipment and apparatuses, and the like are placed on the desk.

Furthermore, an imaging device 24 that is, for example, a camera for imaging an inside of the body and a human sensor 25 that detects a user in the body are provided. Furthermore, a temperature sensor 26 that detects a temperature in the space 2 is provided in the body.

Furthermore, an information acquisition device 29 for acquiring individual information of a user of the space 2 may be provided on an outer surface of the body.

The information acquisition device 29 is, for example, a reader that reads an ID card held by a user. Alternatively, the information acquisition device 29 may be a reader that reads a fingerprint, a pattern of veins, and the like of a user.

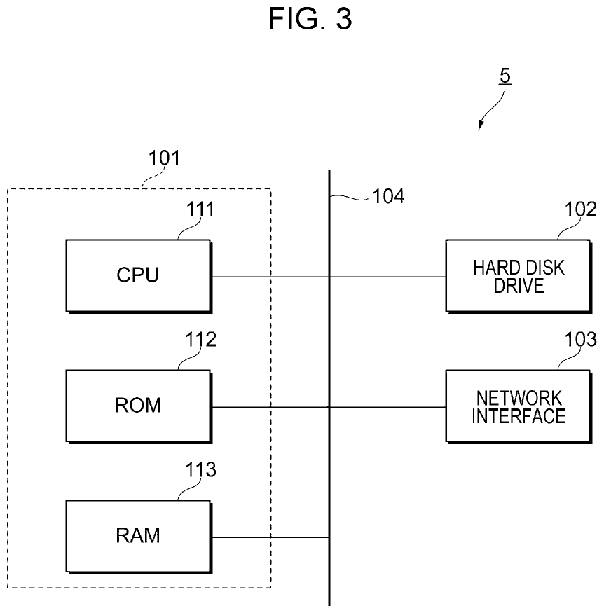

FIG. 3 is a view for explaining an example of a hardware configuration of the space management server 5.

The space management server 5 has a control unit 101 that controls operation of the whole server, a hard disk drive 102 in which data such as management data is stored, and a network interface 103 that achieves communication through a local area network (LAN) cable or the like.

The control unit 101 has a central processing unit (CPU) 111, a read only memory (ROM) 112 in which basic software, a basic input output system (BIOS), and the like are stored, and a random access memory (RAM) 113 used as a work area. The CPU 111 may be a multi-core CPU. The ROM 112 may be a rewritable non-volatile semiconductor memory. The control unit 101 is a computer.

The hard disk drive 102 is a device that writes and reads data into and from a non-volatile storage medium having a disc-shaped substrate coated with a magnetic substance. Note, however, that the non-volatile storage medium may be a semiconductor memory or a magnetic tape.

In addition, the space management server 5 includes an input device such as a keyboard or a mouse and a display device such as a liquid crystal display device as needed.

The control unit 101, the hard disk drive 102, and the network interface 103 are connected through a bus 104 or a signal line (not illustrated).

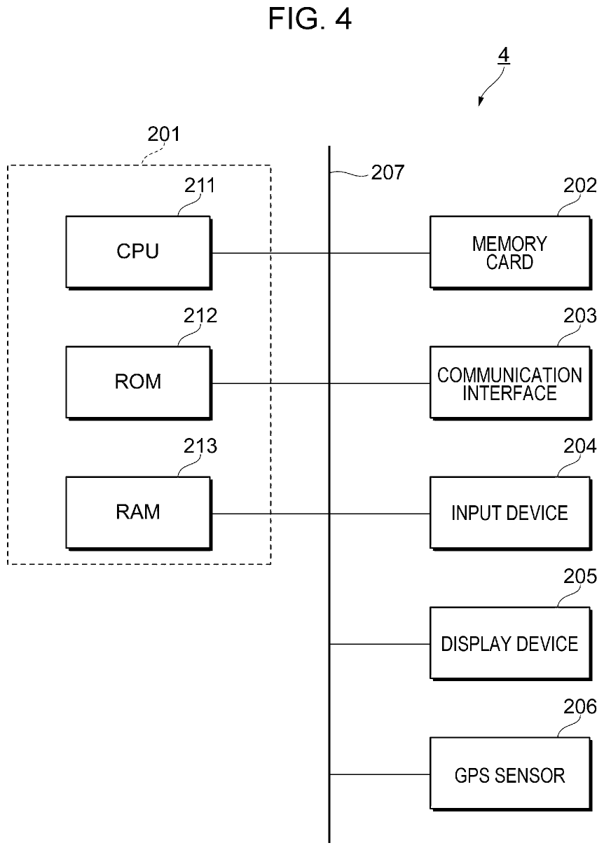

FIG. 4 is a diagram illustrating an example of a hardware configuration of the user terminal 4. FIG. 4 illustrates a case where the user terminal 4 is a smartphone.

The user terminal 4 has a control unit 201 that controls operation of the whole device, a memory card 202 in which various kinds of data are stored, various communication interfaces 203 that are compliant with a wireless communication standard, an input device 204 such as a touch sensor, a display device 205 such as a liquid crystal display device or an electro luminescence display device, and a global positioning system (GPS) sensor 206.

The control unit 201 has a CPU 211, a ROM 212 in which firmware, BIOS, and the like are stored, and a RAM 213 used as a work area. The CPU 211 may be a multi-core CPU. The ROM 212 may be a rewritable non-volatile semiconductor memory.

The communication interfaces 203 are, for example, an interface used for connection with a mobile communication system and an interface used for connection with a wireless LAN.

The GPS sensor 206 is a sensor that measures a position of the user terminal 4 on the basis of a radio wave received from a GPS satellite. Information on latitude, longitude, and altitude supplied from the GPS sensor 206 gives a current position of the user terminal 4. Note that the GPS sensor 206 may support an indoor position measurement system.

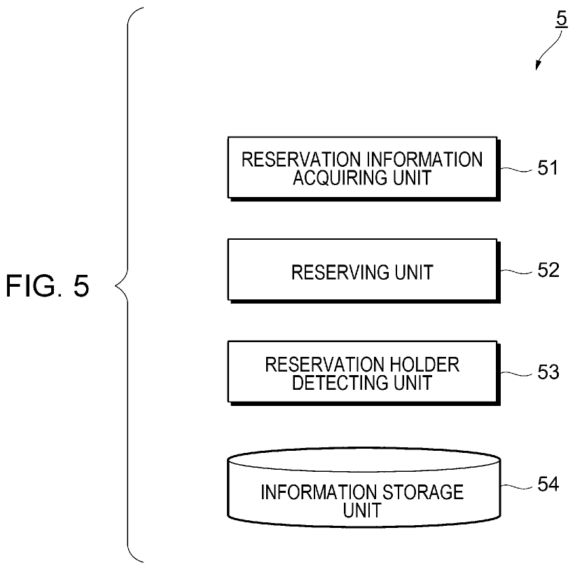

FIG. 5 is a view for explaining an example of a functional configuration of the space management server 5 (see FIG. 1). FIG. 5 illustrates a functional configuration concerning a reservation of the space 2.

The space management server 5 includes a reservation information acquiring unit 51, a reserving unit 52, a reservation holder detecting unit 53, and an information storage unit 54.

Although a case where these functional units are provided in the space management server 5, which is an example of an information processing apparatus, has been described in the present exemplary embodiment, plural information processing apparatuses may be prepared and these functional units may be separately provided in these information processing apparatuses. In this case, an information processing system is constituted by these information processing apparatuses, and the functional units are realized by this information processing system.

The reservation information acquiring unit 51, the reserving unit 52, and the reservation holder detecting unit 53 are realized, for example, by execution of a program by the control unit 101 (see FIG. 3). The information storage unit 54 is realized, for example, by the hard disk drive 102.

The reservation information acquiring unit 51, which is an example of an information acquiring unit, acquires information on a first reservation of a space 2 for a time window made by a user (hereinafter, a user who made a reservation is referred to as a reservation holder).

The reserving unit 52, which is an example of a reserving unit, makes a second reservation to reserve a space for a time window in a case where duration of actual use of this space 2 by the reservation holder is shorter than the time window of this space 2.

The reservation holder detecting unit 53 detects arrival of a reservation holder at a space 2 reserved by this reservation holder. Furthermore, the reservation holder detecting unit 53 detects exit of a reservation holder from a space 2 reserved by this reservation holder.

The information storage unit 54 holds therein information on a reservation of a space 2.

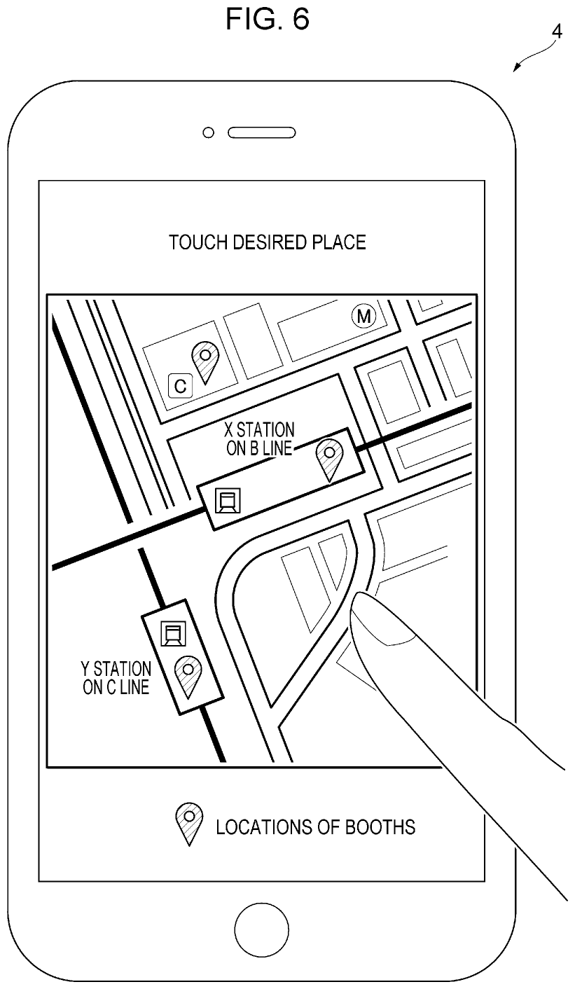

FIG. 6 illustrates an example of a display screen displayed on the user terminal 4 of a user (hereinafter referred to as a reservation applicant) who applies for a reservation when the reservation applicant tries to reserve the space 2.

On the display screen illustrated in FIG. 6, a map is displayed, and plural locations of the spaces 2, which are an example of places to be reserved by a reservation applicant, are displayed on the map.

In the present exemplary embodiment, when a reservation applicant tries to reserve a space 2, the reservation applicant first selects a location from among the plural locations of the spaces 2 on the map.

Note that the way in which the plural locations of the spaces 2 are displayed is not limited to this. For example, the plural locations of the spaces 2 may be displayed in a list form, and the reservation applicant may select a location from the list.

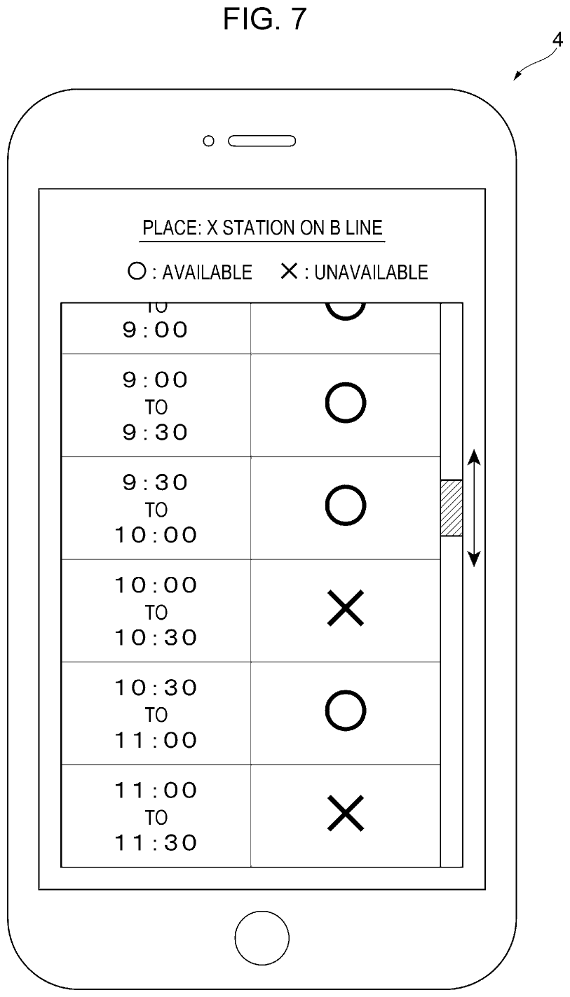

When the reservation applicant selects a location, room availability in each time window at the selected location is displayed as illustrated in FIG. 7, which illustrates another example of a display screen displayed on the user terminal 4.

The reservation applicant designates a time window for which the reservation applicant wants to reserve the space 2 on the display screen and then presses a confirm button (not illustrated).

This causes the space management server 5 to confirm the reservation.

Specifically, the space management server 5 confirms the reservation as follows. The space management server 5 receives information on the location and the reserved time window of the space 2 and registers the information on the location and the reserved time window of the space 2 in the information storage unit 54.

Then, a confirmation result of the reservation is sent to the user terminal 4, and thus the reservation applicant is notified of the confirmation result of the reservation.

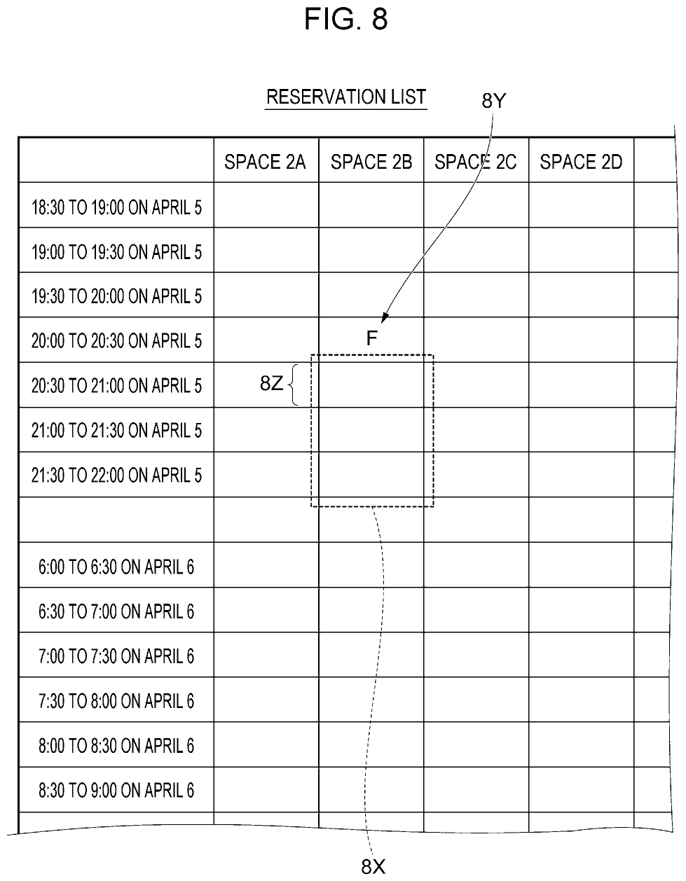

FIG. 8 illustrates a reservation list stored in the information storage unit 54 of the space management server 5.

In the present exemplary embodiment, when a reservation of a space 2 made by a user is confirmed, the user is added as a reservation holder to the reservation list as illustrated in FIG. 8. More specifically, a reservation holder who made a reservation is registered in a field corresponding to a space 2 and a time window reserved by the reservation holder in the reservation list.

In this example, a reservation holder of a space 2B in a time window 20:00 to 20:30 on April 5 is a reservation holder F.

In the present exemplary embodiment, upon receipt of an instruction to unlock a space 2 from a user terminal 4, the space management server 5 compares a user who gave the instruction to unlock the space 2 with users registered in the reservation list, and, if the user who gave the instruction to unlock the space 2 is registered in the reservation list, unlocks the space 2.

More specifically, in the present exemplary embodiment, when a reservation holder tries to unlock a space 2, the reservation holder enters an ID and a password on his or her user terminal 4. Through this authentication process, the operator who is operating the user terminal 4 is identified.

Then, in the present exemplary embodiment, when an instruction to unlock the space 2 is received from the user terminal 4 on which the operator has been authenticated, it is determined whether or not the operator who gave the instruction to unlock the space 2 is registered in the reservation list. In a case where the operator who gave the instruction to unlock the space 2 is registered in the reservation list, the space management server 5 unlocks the space 2.

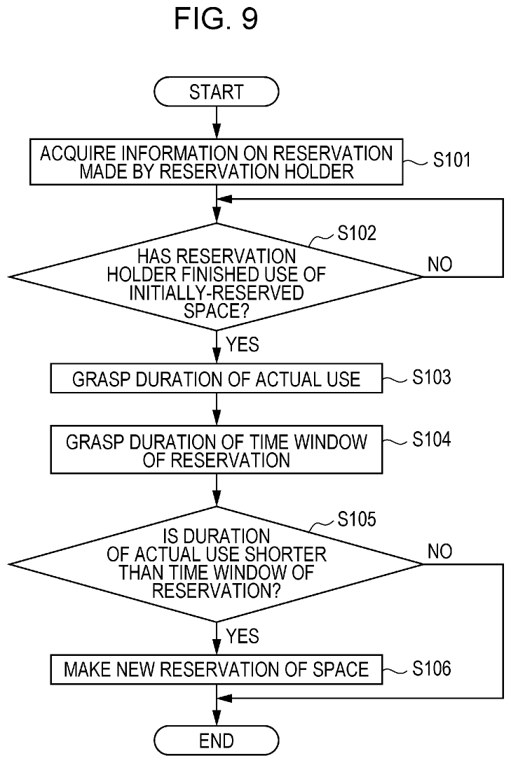

FIG. 9 illustrates an example of flow of automatic reservation processing performed by the space management server 5.

In the present exemplary embodiment, in a case where duration of actual use of a space 2 (hereinafter referred to as an “initially-reserved space 2”) reserved by a reservation holder is shorter than a time window of the initially-reserved space 2, the reserving unit 52 further makes a reservation for this reservation holder.

More specifically, in a case where duration of actual use of an initially-reserved space 2 by a reservation holder is shorter than a time window of the initially-reserved space 2, the reserving unit 52 makes a reservation so that the reservation holder can use the initially-reserved space 2 or another space 2 later.

In this processing, first, the reservation information acquiring unit 51 acquires information on a reservation made by a reservation holder (step 101). In particular, the reservation information acquiring unit 51 acquires information on a reservation of an initially-reserved space 2.

More specifically, the reservation information acquiring unit 51 acquires information on the reservation made by the reservation holder by referring to, for example, the reservation list.

More specifically, the reservation information acquiring unit 51 acquires reservation information including a reservation holder name, the initially-reserved space 2, a start time of a time window of the reservation, and an end time of the time window of the reservation.

Next, in the present exemplary embodiment, the reserving unit 52 determines whether or not use of the initially-reserved space 2 by the reservation holder has been finished (step 102).

Then, in a case where it is determined in step S102 that use of the initially-reserved space 2 has been finished, the reserving unit 52 grasps duration of actual use during which the reservation holder actually used the initially-reserved space 2 (step 103).

Hereinafter, a reservation of an initially-reserved space 2 made by a reservation holder is referred to as an “initial reservation”.

Next, the reserving unit 52 grasps duration of the time window on the basis of the start time and the end time acquired by the reservation information acquiring unit 51 (step 104). More specifically, the reserving unit 52 grasps a difference between the start time and the end time as the duration of the reserved time window.

Then, the reserving unit 52 determines whether or not the duration of actual use is shorter than the reserved time window (step 105). In a case where the duration of actual use is shorter than the reserved time window, the reserving unit 52 newly reserves a space 2 (step 106).

More specifically, in a case where a space 2 is newly reserved, the reserving unit 52 makes a reservation (hereinafter referred to as a “later-use reservation”) so that the reservation holder, who is an example of a user, can use the initially-reserved space 2 initially reserved by the reservation holder or another space 2 later.

Specifically, in a case where duration of actual use of a space 2 reserved by an initial reservation by a reservation holder is shorter than a reserved time window of the initial reservation, the reserving unit 52 newly registers information on the reservation holder in the reservation list and makes a later-use reservation.

In particular, for example, in a case where late arrival of the reservation holder at the initially-reserved space 2, that is, arrival of the reservation holder at the initially-reserved space 2 later than the start time of the time window of the initial reservation is detected, the reserving unit 52 determines that the duration of the actual use is shorter than the reserved time window and makes a later-use reservation.

More specifically, in a case where arrival of the reservation holder at the initially-reserved space 2 later than the start time is detected by the reservation holder detecting unit 53, the reserving unit 52 determines that the duration of the actual use is shorter than the reserved time window and makes a later-use reservation.

Furthermore, in a case where the reservation holder leaves the initially-reserved space 2 early, that is, the reservation holder finishes use of the initially-reserved space 2 before the end time of the initially-reserved space 2, the reserving unit 52 determines that the duration of actual use is shorter than the reserved time window and makes a later-use reservation.

More specifically, in a case where exit of the reservation holder from the initially-reserved space 2 before the end time is detected by the reservation holder detecting unit 53, the reserving unit 52 determines that the reservation holder has finished use of the initially-reserved space 2 before the end time and makes a later-use reservation.

In the present exemplary embodiment, arrival of the reservation holder at the initially-reserved space 2 later than the start time and exit of the reservation holder from the initially-reserved space 2 before the end time are detected by the reservation holder detecting unit 53.

The reservation holder detecting unit 53 detects arrival of the reservation holder at the initially-reserved space 2 later than the start time and exit of the reservation holder from the initially-reserved space 2 before the end time, for example, on the basis of output from the human sensor 25, the information acquisition device 29, the imaging device 24, and the electronic lock 22C.

Specifically, the reservation holder detecting unit 53 detects detection of a person by the human sensor 25, reading of an ID card of the reservation holder by the information acquisition device 29, capturing of the reservation holder by the imaging device 24, unlocking of the electronic lock 22C by the reservation holder, or the like.

Upon detection of any of these kinds of output after the start time, the reservation holder detecting unit 53 outputs a detection result indicating arrival of the reservation holder at the initially-reserved space 2 later than the start time.

The reservation holder detecting unit 53 detects absence of detection of a person by the human sensor 25, reading of an ID card of the reservation holder (who tries to leave the space 2) by the information acquisition device 29, absence of detection of the reservation holder in an image taken by the imaging device 24, locking of the electronic lock 22C by the reservation holder, or the like.

Upon detection of any of these kinds of output before the reserved end time, the reservation holder detecting unit 53 outputs a detection result indicating exit of the reservation holder from the initially-reserved space 2 before the end time.

The reserving unit 52 need not always make a later-use reservation in a case where the duration of actual use is shorter than the reserved time window. For example, the reserving unit 52 may make a later-use reservation in a case where the duration of actual use is shorter than the reserved time window and a difference between the duration of actual use and duration of the reserved time window is larger than a predetermined period.

Furthermore, the reserving unit 52 may make a reservation upon receipt of consent to reserve the reservation from the reservation holder.

Specifically, in this case, for example, the reserving unit 52 inquires the reservation holder about whether or not to permit a later-use reservation through the user terminal 4 before the later-use reservation is confirmed. In a case where a reply to the inquiry is positive, the reserving unit 52 makes the later-use reservation.

In other words, in a case where a reply to the inquiry is positive, the reserving unit 52 adds the reservation holder of the initial reservation to the reservation list and makes the later-use reservation.

In a case where a user who reserved a space 2 arrives late at the space 2 or leaves the space 2 early, duration of actual use during which the user actually uses the reserved space 2 is shorter than an originally-intended reserved time window.

In this case, for example, if the user makes a reservation of a space 2 again by himself or herself, the user can make up for the time he/she missed due to his/her late arrival or early leave. However, making a reservation again is troublesome for the user.

Meanwhile, in the present exemplary embodiment, the reserving unit 52 automatically makes a reservation again. This lessens user's trouble and improves user's convenience.

In a case where a reservation is automatically made again as in the present exemplary embodiment, users are prompted to use the spaces 2 as compared with a case where the user makes a reservation again by himself or herself. This gives more opportunities to charge users a fee, thereby improving earnings of an administrator of the spaces 2.

Examples of a fee charging method include a method for charging users a fee in accordance with a period of use of a space 2. In this case, the configuration in which a reservation is automatically made gives more opportunities for users to use a space 2 and gives more opportunities to charge users a fee accordingly. This improves earnings of the administrator.

Furthermore, in a case where a reservation is automatically made again as in the present exemplary embodiment, users are less likely to cancel a reservation at the last moment. This also gives more opportunities to charge users a fee, thereby improving earnings of the administrator of the spaces 2.

Assume that a user cannot make up for the time he/she missed due to his/her late arrival or early leave. In this case, if a user arrives late at the space 2 or leaves the space 2 early, the user suffers a loss because there is a period during which the user cannot use the space 2. For this reason, a user who will arrive late at the space 2 or leave the space 2 early tends to cancel a reservation of the space 2 immediately before a start time of a time window of a reservation.

More specifically, assume that a contract stipulates that users are charged a fee per unit time irrespective of a period of use and are not charged a cancellation fee if the users make cancellation before a start time of a time window of a reservation.

In this case, a user who arrives late at the space 2 or leaves the space 2 early is charged a fee even for a period during which the user cannot use the space 2. This encourages the user who will arrive late at the space 2 or leave the space 2 early to cancel the reservation at the last moment.

If the user cancels the reservation at the last moment, it is hard to find a next new user soon. This creates a vacant space 2, thereby providing fewer opportunities for earnings of the administrator.

Meanwhile, according to the configuration of the present exemplary embodiment, even if a reservation holder arrives late at an initially-reserved space 2 after a start time of a time window of an initial reservation, the reservation holder is not charged a fee for the time the reservation holder missed. Furthermore, a later-use reservation allows the reservation holder to make up for the time he/she missed due to his/her late arrival.

In particular, in the present exemplary embodiment, users are charged a fee in accordance with a period of use. Accordingly, even if a reservation holder arrives late at an initially-reserved space 2 after a start time of time window of an initial reservation, the reservation holder is not charged a fee for the time the reservation holder missed. Furthermore, a later-use reservation allows the reservation holder to make up for the time he/she missed due to his/her late arrival.

This discourages the user from cancelling the reservation, thereby increasing a possibility of arrival of the user at the initially-reserved space 2. This gives more opportunities to charge users a fee, thereby improving earnings of the administrator.

In the present exemplary embodiment, if a reservation holder does not arrive at an initially-reserved space 2 until an end time of a time window of a reservation without cancellation, the reservation holder is charged a fee corresponding to a time window of the reservation.

The reserving unit 52 may be configured to make a later-use reservation only a predetermined number of times (e.g., only one time).

For example, although it is also possible to employ a configuration in which if a later-use reservation is cancelled, the reserving unit 52 further makes a later-use reservation, the above configuration in which the reserving unit 52 can make a later-use reservation only one time prevents the reserving unit 52 from making another later-use reservation.

Details of reservation processing performed by the reserving unit 52 are described below.

The reserving unit 52 automatically makes a later-use reservation, for example, so that the later-use reservation is made on a date (hereinafter referred to as an “initially-reserved date”) on which an initial reservation has been made.

In particular, the reserving unit 52 makes a later-use reservation so that the later-use reservation is made on an initially-reserved date on which late arrival or early leaving occurred.

Specifically, for example, the reserving unit 52 makes a later-use reservation in any of time windows indicated by reference sign 8X in FIG. 8.

In the example illustrated in FIG. 8, a reservation indicated by reference sign 8Y is an initial reservation. In this case, the reserving unit 52 makes a later-use reservation in any of time windows indicated by reference sign 8X in FIG. 8.

More specifically, in this example, the initially-reserved date is April 5, and the reserving unit 52 makes a later-use reservation on April 5 in a time window later than a time window of the initial reservation.

FIG. 8 illustrates an example in which the reserving unit 52 makes a later-use reservation to reserve a space 2B. In this case, the reserving unit 52 makes a later-use reservation to reserve the space 2B, which is the same as an initially-reserved space 2 reserved by an initial reservation.

Furthermore, in a case where the reserving unit 52 makes a later-use reservation on an initially-reserved date, the reserving unit 52 may make the later-use reservation so that a time window of the later-use reservation follows a time window of the initial reservation.

More specifically, the reserving unit 52 may make a later-use reservation to reserve a space 2 same as an initially-reserved space 2 reserved by an initial reservation. In this case, if a time window that immediately follows the time window of the initial reservation is available, the reserving unit 52 may make the later-use reservation in this time window.

More specifically, in a case where a time window indicated by reference sign 8Z in FIG. 8 is available, the reserving unit 52 may make the later-use reservation in the time window indicated by reference sign 8Z in FIG. 8.

Alternatively, the reserving unit 52 may make a later-use reservation to reserve a space 2 same as an initially-reserved space 2 in an available time window closest to a time window of an initial reservation among available time windows that follow the time window of the initial reservation.

The above description has discussed an example in which in a case where a later-use reservation is made on an initially-reserved date, the later-use reservation is made for a space 2 same as an initially-reserved space 2 reserved by an initial reservation.

Note, however, that this configuration is not restrictive. In a case where a later-use reservation is made on an initially-reserved date, the later-use reservation may be made for a space 2 different from an initially-reserved space 2.

Even in a case where the reserving unit 52 reserves a space 2 different from an initially-reserved space 2, a reservation holder who made an initial reservation can go to this different space 2 if this different space 2 is close to the initially-reserved space 2, as described later.

In this case, even in a case where the reserving unit 52 reserves a space 2 different from an initially-reserved space 2, a reservation holder who made an initial reservation can use this different space 2 for the time the reservation holder missed due to his or her later arrival.

Alternatively, the reserving unit 52 may make a later-use reservation so that a time window of the later-use reservation and a time window of another reservation that has been made by the reservation holder are on a same date.

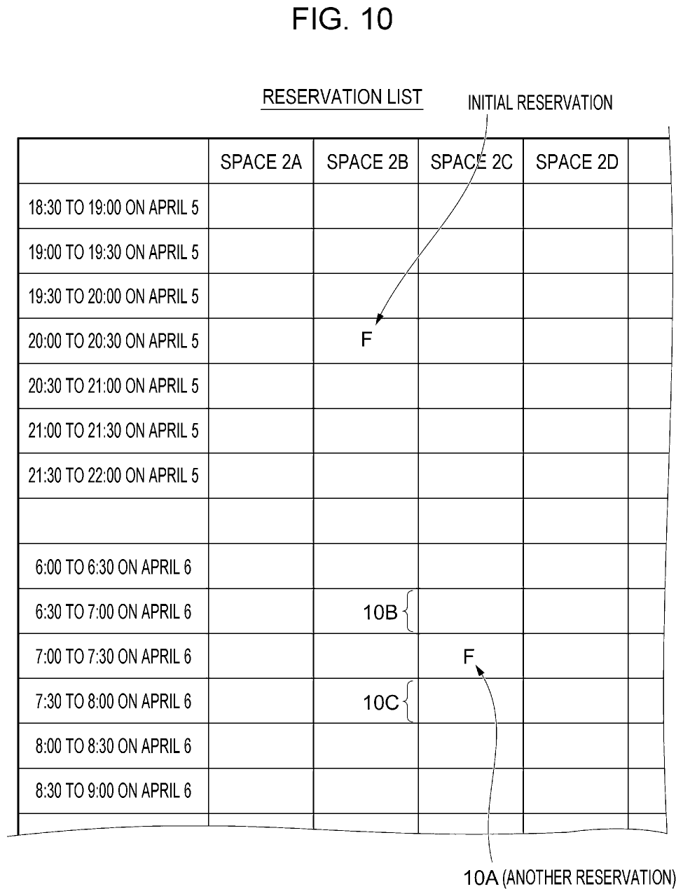

Specifically, for example, in a case where a reservation holder has made another reservation on April 6, which is different from a date of an initial reservation, as indicated by reference sign 10A in FIG. 10 (illustrating another example of a reservation list), the reserving unit 52 may make a later-use reservation so that a time window of the later-use reservation is on this different date.

In this case, the reserving unit 52 may make the later-use reservation so that the time window of the later-use reservation and the time window of the other reservation are adjoining to each other. Specifically, the reserving unit 52 may make the later-use reservation in a time window indicated by reference sign 10B in FIG. 10 or in a time window indicated by reference sign 10C in FIG. 10.

FIG. 10 illustrates an example in which the reserving unit 52 makes a later-use reservation to reserve a space 2 same as a space 2 for which another reservation has been made.

More specifically, in the example illustrated in FIG. 10, the space 2 for which the other reservation has been made is a space 2C, and the later-use reservation is also made for the space 2C.

Although a case where the reserving unit 52 makes a later-use reservation to reserve a space 2 same as a space 2 for which a reservation holder has already made another reservation has been described above, this configuration is not restrictive. The reserving unit 52 may make a later-use reservation to reserve a space 2 different from the space 2 for which the reservation holder has already made another reservation.

The reserving unit 52 may make a later-use reservation to reserve a space 2 same as a space 2 for which another reservation has been made so that the later-use reservation is made in an available time window closest to the time window of the other reservation among time windows before and after the time window of the other reservation.

In a case where the reserving unit 52 makes a later-use reservation to reserve a space 2 different from an initially-reserved space 2, the reserving unit 52 may make the later-use reservation to reserve a space 2 within a predetermined distance from the initially-reserved space 2.

In other words, in a case where the reserving unit 52 makes a later-use reservation to reserve a different space 2, the reserving unit 52 may make the later-use reservation to reserve a space 2 close to the initially-reserved space 2.

In this case, the reserving unit 52 may make a later-use reservation to reserve a space 2 closest to the initially-reserved space 2.

In a case where the reserving unit 52 makes a reservation (later-use reservation) of another space 2 on the basis of an initially-reserved space 2, the reserving unit 52 decides the other space 2 by referring to a space database and reserves the other space 2.

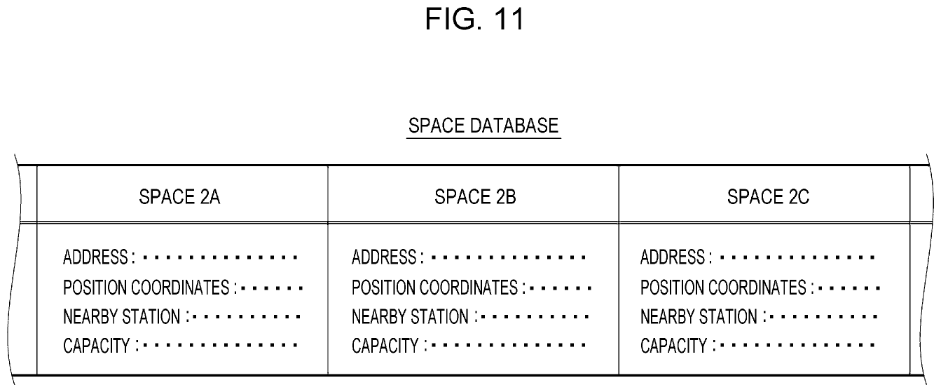

FIG. 11 illustrates a space database.

The information storage unit 54 according to the present exemplary embodiment stores therein the space database illustrated in FIG. 11. In this space database, information on an address, position coordinates, a closest station, a capacity, and the like of each of the spaces 2 is stored.

For example, the reserving unit 52 specifies another space 2 within a predetermined distance from the initially-reserved space 2 or specifies another space 2 closest to the initially-reserved space 2 by referring to this space database.

In a case where the reserving unit 52 makes a later-use reservation to reserve another space 2 different from an initially-reserved space 2, the reserving unit 52 may make the later-use reservation to reserve another space 2 whose nearby station is the same as a nearby station of the initially-reserved space 2.

This is described below by using a specific example. For example, in a case where the nearby station of the initially-reserved space 2 is a station A, the reserving unit 52 may select and reserve another space 2 whose nearby station is the station A among candidates for the other space 2.

Since information on a nearby station is also registered in the space database in the present exemplary embodiment, the reserving unit 52 acquires information on a nearby station by referring to the space database.

Although a case where a reservation holder who reserved an initially-reserved space 2 uses a space 2 for which a later-use reservation has been made has been described above, an authority to use the space 2 for which the later-use reservation has been made may be given to another person, and this person may use this space 2.

Furthermore, an authority to use an initially-reserved space 2 may be given from a reservation holder who reserved the initially-reserved space 2 to another person (another user), and this person may use the initially-reserved space 2.

In a case where such a usage authority is given to another person, for example, a reservation holder of an initially-reserved space 2 first selects a user to be given the usage authority by operating the user terminal 4.

In the present exemplary embodiment, the selected user is registered in the reservation list. Then, in the present exemplary embodiment, upon receipt of an unlocking instruction from the selected user, the space management server 5 unlocks a space 2 for which a later-use reservation has been made or the initially-reserved space 2.

Next, a time window of a later-use reservation is described.

For example, in a case where a reservation holder starts use of an initially-reserved space 2 after a start time of a time interval of an initial reservation, the reserving unit 52 decides a time window of a later-use reservation on the basis of an elapsed time from the start time of the time interval of the initial reservation to the start of the use of the initially-reserved space 2.

More specifically, in a case where arrival of a reservation holder at an initially-reserved space 2 later than a start time of a time window of an initial reservation is detected by the reservation holder detecting unit 53, the reserving unit 52 determines that the reservation holder has started use of the initially-reserved space 2 after the start time of the time window of the initial reservation.

In this case, the reserving unit 52 decides a time window of a later-use reservation on the basis of an elapsed time from the start time of the time window of the initial reservation to the start of the use of the initially-reserved space 2 (an elapsed time from the start time of the time window of the initial reservation to the detection of arrival of the reservation holder at the initially-reserved space 2 by the reservation holder detecting unit 53).

More specifically, for example, the reserving unit 52 decides the time window of the later-use reservation so that duration of the time window of the later-use reservation corresponds to the elapsed time.

Alternatively, for example, the reserving unit 52 decides the time window of the later-use reservation so that duration of the time window of the later-use reservation is shorter than the elapsed time.

Alternatively, the reserving unit 52 may decide the time window of the later-use reservation so that duration of the time window of the later-use reservation corresponds to a multiple of a predetermined unit time. More specifically, in this case, for example, in a case where the predetermined unit time is 15 minutes, the reserving unit 52 decides a multiple of 15 minutes as duration of the time window of the later-use reservation.

The reserving unit 52 may decide, as the duration of the time window of the later-use reservation, a period that is shorter than the elapsed time and is closest to the elapsed time among multiples of a predetermined unit time.

In this case, for example, in a case where the predetermined unit time is, for example, 15 minutes and the elapsed time is 20 minutes, the reserving unit 52 decides 15 minutes as the time window of the later-use reservation.

The reserving unit 52 may be configured not to make a later-use reservation in a case where the elapsed time is shorter than a predetermined period, for example, in a case where the elapsed time is less than 5 minutes.

Alternatively, the reserving unit 52 may be configured not to make a later-use reservation in a case where the elapsed time is shorter than the unit time.

Although processing performed in a case where a reservation holder arrives after a start time of a time window of a reservation has been mainly described, the above processing may be also applied to a case where a reservation holder leaves a space 2 before an end time of a time window of a reservation. In particular, the above processing may also be applied to a case where a reservation holder leaves a space 2 early.

In other words, the processing may also be applied to a case where a reservation holder finishes use of an initially-reserved space 2 before an end time of time window of an initial reservation.

In a case where a reservation holder finishes use of an initially-reserved space 2 before an end time a time window of the initial reservation, the reserving unit 52 decides duration of a time window of a later-use reservation, for example, on the basis of a time from the end of the use of the initially-reserved space 2 to the end time of the time window of the initial reservation.

More specifically, in a case where exit of a reservation holder from an initially-reserved space 2 before an end time of a time window of an initial reservation is detected by the reservation holder detecting unit 53, the reserving unit 52 determines that the reservation holder has finished use of the initially-reserved space 2 before the end time of the time window of the initial reservation.

In this case, the reserving unit 52 decides duration of a time window of a later-use reservation on the basis of a time from the end of the use of the initially-reserved space 2 to the end time of the time window of the initial reservation.

The above processing may also be applied to a case where a reservation holder arrives at an initially-reserved space 2 after a start time of a time window of an initial reservation and leaves the initially-reserved space 2 early.

In this case, the reserving unit 52 decides duration of a time window of a later-use reservation on the basis of an elapsed time from the start time of the time window of the initial reservation to start of actual use of the initially-reserved space 2 and a time from the end of the use of the initially-reserved space 2 to the end time of the time window of the initial reservation.

In particular, in this case, the reserving unit 52 decides duration of the time window of the later-use reservation on the basis of a sum of the elapsed time from the start time of the time window of the initial reservation to start of the actual use of the initially-reserved space 2 and the time from the end of the use of the initially-reserved space 2 to the end time of the time window of the initial reservation.

Although processing performed in a case where a reservation holder who reserved an initially-reserved space 2 is a user of the initially-reserved space 2 and this reservation holder arrives at the initially-reserved space 2 later than a start time of a time window of an initial reservation or leaves the initially-reserved space 2 early has been described above, the processing may also be applied to a case where a person other than the reservation holder is a user of the initially-reserved space 2.

In the present exemplary embodiment, as described above, an authority to use an initially-reserved space 2 can be given from a reservation holder who reserved the initially-reserved space 2 to another person, and this person can use the initially-reserved space 2. In this case, this person may arrive at the initially-reserved space 2 later than a start time of a time window of an initial reservation or leave the initially-reserved space 2 early. The processing may also be applied to a case where this person is a user of the initially-reserved space 2.

In such a case where another person is a user of an initially-reserved space 2, a usage authority of a later-use reservation may be given to this user (the other person) or may be given to a person (e.g., a reservation holder) other than this user.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
one or more processors programmed to:
acquire information on a first reservation of a first place for a first time window,
determine whether duration of actual use of the first place by a user is shorter than the first time window of the first reservation, and
in response to determining that the duration is shorter than the first time window, make a second reservation to reserve the first place or a second, different place for a second time window.

2. The information processing system according to claim 1, wherein the one or more processors are programmed to:
determine whether a detected arrival of the user at the first place is later than a start time of the first time window of the first reservation, and
in response to the arrival of the user at the first place being later than the start time of the first time window, determine that the duration of the actual use of the first place is shorter than the first time window.

3. The information processing system according to claim 1, wherein
the one or more processors are programmed to make the second reservation in response to receiving, from the user, consent to make the second reservation.

4. The information processing system according to claim 1, wherein
the one or more processors are programmed to make the second reservation so that the second reservation and the first reservation are on a same date.

5. The information processing system according to claim 4, wherein
the one or more processors are programmed to make the second reservation so that the second time window follows the first time window.

6. The information processing system according to claim 1, wherein
the one or more processors are programmed to make the second reservation so that the second time window of the second reservation and a third time window of a third reservation for the user are on a same date.

7. The information processing system according to claim 6, wherein
the one or more processors are programmed to make the second reservation so that the second time window and the third time window are adjoining to each other.

8. The information processing system according to claim 6, wherein
the first place reserved by the second reservation or the second place reserved by the second reservation is reserved by the third reservation.

9. The information processing system according to claim 1, wherein
in a case where the second reservation is made to reserve the second place, the second place is within a predetermined distance from the first place.

10. The information processing system according to claim 1, wherein
in a case where the second reservation is made to reserve the second place, the second place has a nearby station that is the same as a nearby station of the first place.

11. The information processing system according to claim 1, wherein
in response to the user starting use of the first place after a start time of the first time window, the one or more processors are programmed to decide the second time window based on an elapsed time from the start time of the first time window to start of the use of the first place.

12. The information processing system according to claim 11, wherein
in response to a detected arrival of the user at the first place being later than the start time of the first time window, the one or more processors are programmed to determine that the user has started use of the first place after the start time of the first time window and to decide the second time window based on the elapsed time from the start time of the first time window to the start of the use of the first place.

13. The information processing system according to claim 11, wherein
the one or more processors are programmed to decide the second time window so that duration of the second time window corresponds to the elapsed time.

14. The information processing system according to claim 11, wherein
the one or more processors are programmed to decide the second time window so that duration of the second time window is shorter than the elapsed time.

15. The information processing system according to claim 11, wherein
the one or more processors are programmed to not make the second reservation in a case where the elapsed time is shorter than a predetermined period.

16. The information processing system according to claim 1, wherein
the one or more processors are programmed to decide the second time window so that duration of the second time window corresponds to a multiple of a predetermined unit time.

17. The information processing system according to claim 1, wherein
in response to the user finishing use of the first place before an end time of the first time window, the one or more processors are programmed to decide the second time window based on a time from end of use of the first place to an end time of the first time window.

18. An information processing apparatus comprising:
a processor programmed to:
acquire information on a first reservation of a first place for a first time window,
determine whether duration of actual use of the first place by a user is shorter than the first time window of the first reservation, and
in response to determining that the duration is shorter than the first time window, make a second reservation to reserve the first place or a second, different place for a second time window.

19. A non-transitory computer readable medium storing a program causing a computer to execute a process for information processing, the process comprising:
acquiring information on a first reservation of a first place for a first time window;
determining whether duration of actual use of the first place by a user is shorter than the first time window of the first reservation; and
in response to determining that the duration is shorter than the first time window, making a second reservation to reserve the first place or a second, different place for a second time window.
